(19) United States
(12) Patent Application Publication
(10) Pub. No.: US 2012/0005284 A1
(43) Pub. Date: Jan. 5, 2012

(54) Adaptive Method to Automatically Classify Emails Based on Bio-Signature Association

(76) Inventor: Edward T. Tse, Anaheim, CA (US)

(21) Appl. No.: 12/830,316

(22) Filed: Jul. 3, 2010

(51) Int. Cl. G06F 15/16

(52) U.S. Cl. 709/206

(57) ABSTRACT

The Bio-Signature Association approach disclosed herein addresses the above stated needs by providing a method and computer software component for automatically and intelligently managing the inbox based on the ever-changing behavior of the user. Theoretically, Emails should be treated as an event where an action may be taken or initiation of an action.

When the user casually acts upon an inbox or an individual email, there is unique pattern associated with such operations. For example, one might view emails from families first followed by colleagues or so-call “internal” fellow workers. Naturally, pushed advertisements such as special interest groups and vendors may be towards the end. These viewing habits and patterns are considered as unique “signature” for each user in this invention.

### CROSS REFERENCE TO RELATED APPLICATIONS

Not Applicable.

### FIELD OF THE DISCLOSURE

The present disclosure relates to classifying the level of importance of electronic mails (emails) and more specifically, the relationship and characteristics of bio-signature as relates to email classifications.

### BACKGROUND OF THE INVENTION

1. Field

The present invention relates to email organization, email viewing alternatives, and more specifically intelligently prioritize emails to only present emails with high-level of importance ranked by user habits. This technique is referred to as Bio-Signature Association. 2. Background

Today email is a widely accepted a form of communication in most businesses and households. The vast majority of people who own computers or have Internet access use email to communicate on a regular basis. Emails can be the primary source of communication for businesses. With this advancement of modern Email communication technology and fast internet infrastructure, it is inevitable we will be inundated with emails on a daily basis. Inbox mail cluttering by junk emails, email of lesser importance and FYI type of information hampers the productivity of office workers significantly.

What is needed is an algorithm and a software component where an email can be discerned as various level of importance based on automated (artificially intelligent) method. The method must be adaptive to the user's behavior over time. People's job, responsibility, social network and roles may change. In order for a method to be highly useful and applicable to all situations, it must change according to real-life situations. This method is called “Bio-Signature Association”. It is all-encompassing, adaptive and can be over-ridden.

### SUMMARY

Embodiments of the present invention include a method for classifying emails for the purpose of ranking emails importance and the display method of valued incoming emails. The classification is by virtue of tracking user viewing habit—bio-signature recognition. The resulting classification can be used to rank the importance of a “sender”, “content” or “organization”. Email importance can be ranked by scoring the weights assigned based on bio-rules. These rules are specifically specified using the author's bio-recognition technique.

The Bio-Signature Association approach disclosed herein addresses the above stated needs by providing a method and computer software for automatically and intelligently managing the inbox based on the ever-changing behavior of the user. Theoretically, Emails should be treated as an event where an action may be taken or initiation of an action. This method does not address or evaluation the importance of “initiated emails”: only incoming emails are evaluated. We consider starting an email is a random event from the perspective of automation.

When the user acts upon an inbox entry or an individual email, there is unique pattern associated with such operation. For example, one might view emails from families first followed by colleagues or so-call “internal” fellow workers. Naturally, pushed advertisements such as special interest groups and vendors may be towards the end. These viewing habits may change over time. These patterns can be considered as unique for each user and hence the associating the word “signature” in this invention.

To provide a naturally efficient viewing panel into such groups of classified emails, this claim embodies a special view panel. This viewing panel shows the users the emails that are most likely important to the user. Its presentation must be simple in concept, natural and familiar to use, and quick to display.

| | | |
|---|---|---|
| 5768505 | June 1998 | Gilchrist et al. |
| 6301245 | October 2001 | Luzeski et al. |
| 2008/0120556 | May 2008 | Bedingfield et al. |

### BRIEF DESCRIPTION OF THE DRAWINGS AND TABLES

The accompanying drawings which are incorporated in and constitute part of the specification, illustrates various embodiments of the invention. Together with the general description, the drawings serve to explain the principles of the invention. In the drawings:

FIG. 1 depicts an exemplary for general attributes of a typical email; list of attributes, behavior and values to partially characterize the Bio-Signature Association method;

FIG. 2 depicts an exemplary Viewing Panel of a typical Email Client (such as Microsoft Outlook);

FIG. 3 depicts exemplary Viewing Panel for displaying the resulting group of fully classified emails in a user-friendly and viewing-friendly manner (in standard chronological order); and

FIG. 4 depicts exemplary Viewing Panel for displaying the resulting group of fully classified emails in the form of a priority queues displayed in a tree structure.

### DETAILED DESCRIPTION

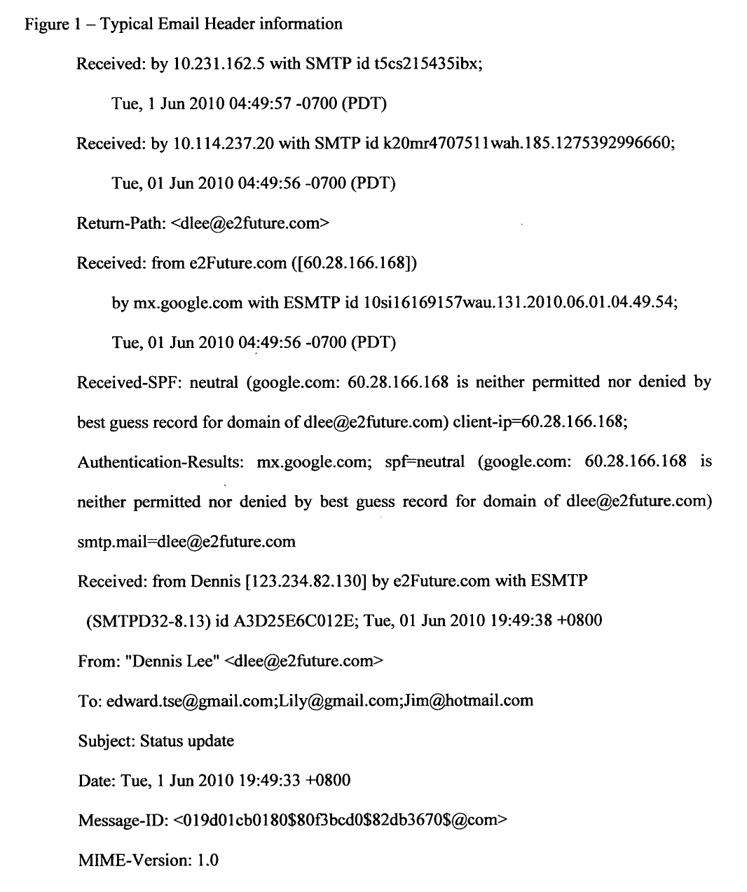

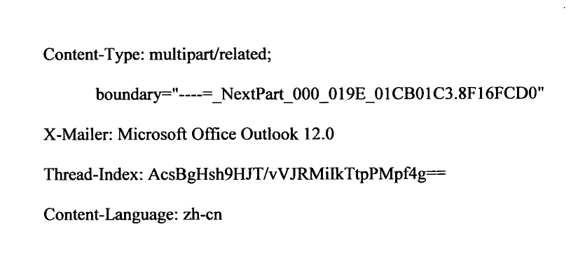

FIG. 1 depicts an exemplary for general attributes of a typical email; list of attributes, behavior and values to properly characterize the Bio-Signature Association method. From this standard SMTP or ISO conformed Email Header, we can extract path information, source and destination identifications, and the time signature of each email. This information contributes to a portion of deterministic characteristics of Bio-Signature Association. Other attributes such as viewing habits, reply/forward time, and delete time are not specified here. They are delineated in the CLAIM section below.

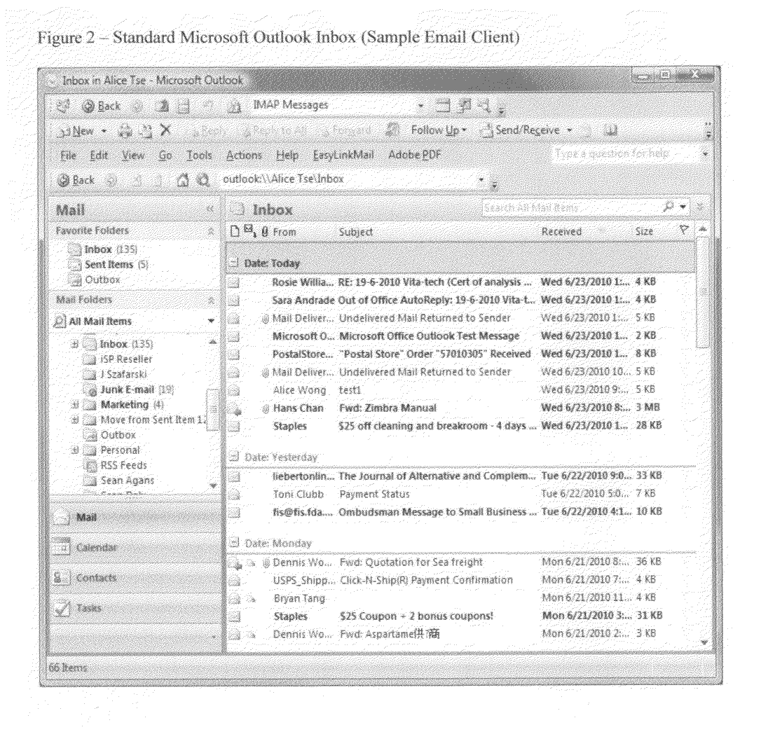

FIG. 2 depicts an exemplary Viewing Panel of a typical Email Client (such as Microsoft Outlook). In order to view Emails, a computer system employs a program typically called an Email Client. This panel displays information that is commonly found: Emails in chronological order, grouping based on a tree folder concept, and a preview panel where the content of an email is displayed when an email is “clicked”. Note that “click” operations may mean opening an email in a new window or just updating a docked panel inside the client system.

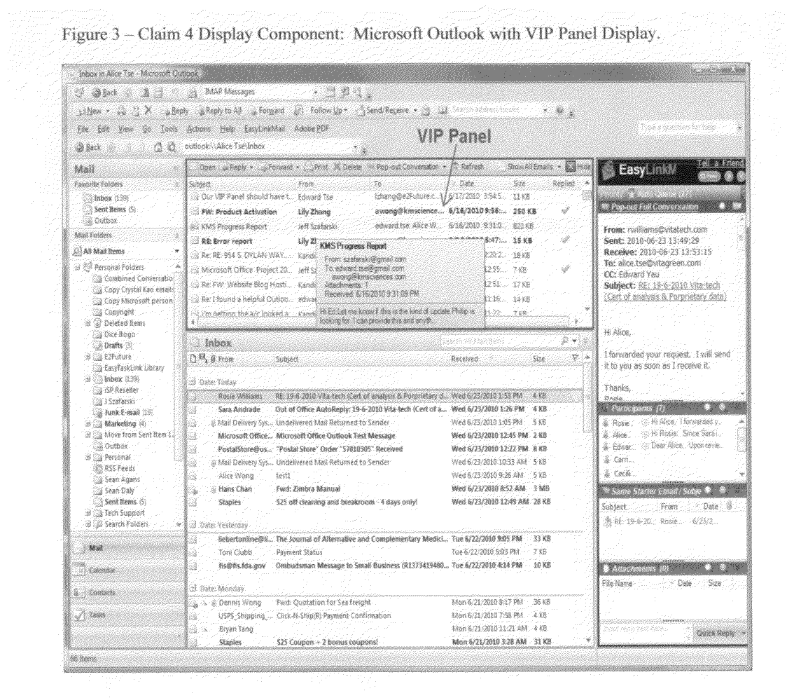

FIG. 3 depicts an exemplary Viewing Panel for displaying the resulting group of fully classified emails in a user-friendly and viewing-friendly manner (in standard chronological order). After the group of candidate emails is selected, they will be listed in an order that is consistent with the hosting Email Client (from FIG. 1.)

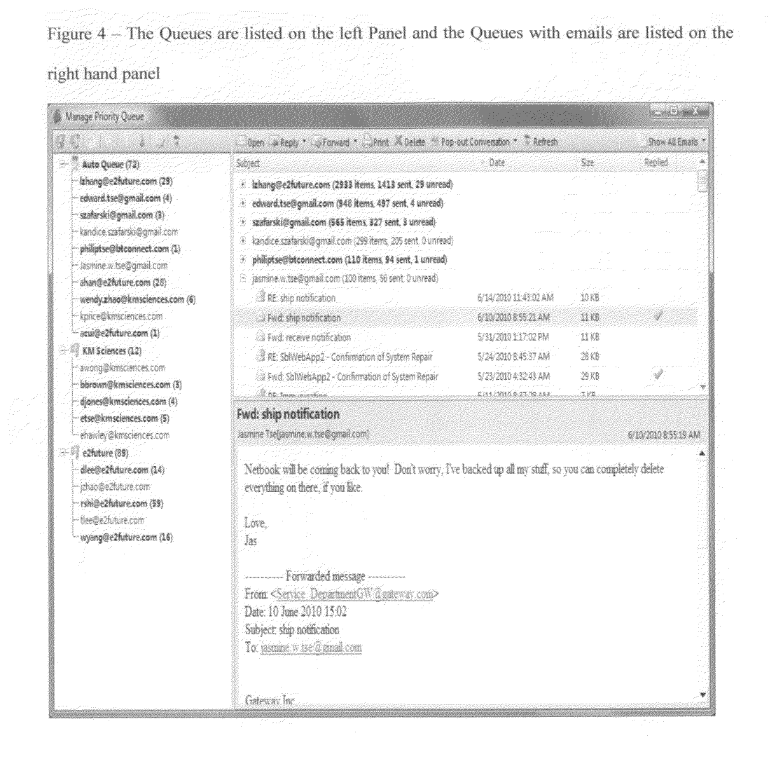

FIG. 4 depicts an exemplary Viewing Panel for displaying the resulting group of fully classified emails in the form of a priority queues displayed in a tree structure. While the Viewing Panel in FIG. 3 is presented in a linear list ordered in chronological order of receipt timestamp, we can view the group of candidate emails in a tree view. The first level tree node lists the “Priority Queues” while the children of each “Priority Queue” are the emails contained thereof. The “Priority Queues” are determined automatically based on Bio-Signature Association or manually configured.

The foregoing description has been presented for purposes of illustration and description. It is not intended to be exhaustive or to limit the disclosure to the precise forms disclosed. Obvious modifications or variations are possible in light of the above description. The implementations and attributes discussed, however, were chosen and described to illustrate the principles of the disclosure and its practical application to thereby enable one of ordinary skill in the profession to utilize the disclosure in various implementations and with various modifications suited to the contemplated usage.

What we claim is:

1. A method of managing emails to remove inbox cluttering. This Bio-Signature Association method is totally self-deterministic so the users do not have to explicitly define rules.
a. The method of claim 1, wherein the condition of removal must be that the current user environment, inbox arrangement, user work habits and data content must not be altered in any shape or form.
b. The method of claim 1, wherein the actual analysis and process is fully automatic.
There is no need for the user to cognitively aware of how the method can create such grouping.
c. The method of claim 1, wherein the process can be altered or adjusted by the user if so desired.
d. The method of claim 1, further comprising: a database configured to store sender's attributes, tallies bio-signature related parameters, and computer program execution environment. This database can be rebuilt or removed from the current user environment without affecting the original user system.

2. A method to automatically and dynamically evaluate importance of emails in the inbox.
a. The method of claim 2, wherein the Bio-Signature Groups are identified as “Routing Information”, “Identifications”, “Access Behavior” and “Temporal”.
b. The method of claim 2 wherein an attribute for determining Bio-Signature Groups is whether a “delete” operation has been performed.
c. The method of claim 2 wherein an attribute for determining Bio-Signature Groups is whether a “read” operation has been performed.
d. The method of claim 2 wherein an attribute for determining Bio-Signature Groups is when a “read” operation has been performed. In this context, “when” is calculated from the time when the email client is started or the time-of-day.
e. The method of claim 2 wherein an attribute for determining Bio-Signature Groups is whether a “reply” operation has been performed.
f. The method of claim 2 wherein an attribute for determining Bio-Signature Groups is when a “reply” operation has been performed. In this context, “when” is calculated from the time when the email client is started or the time-of-day.
g. The method of claim 2 wherein an attribute for determining Bio-Signature Groups is whether a “forward” operation has been performed.
h. The method of claim 2 wherein an attribute for determining Bio-Signature Groups is when a “forward” operation has been performed. In this context, “when” is calculated from the time when the email client is started or the time-of-day.
i. The method of claim 2 wherein an attribute for determining Bio-Signature Groups is whether a “SUBSCRIBE/UNSUBSCRIBE” word is found in the email content.
j. The method of claim 2 wherein an attribute for determining Bio-Signature Groups is when an operation has been performed in the time of day. For example, the emails that are being “read” immediately after opening the email client will be ranked more important.
k. The method of claim 2 wherein an attribute for determining Bio-Signature Groups is the frequency of an email being “read”.
l. The method of claim 2 wherein an attribute for determining Bio-Signature Groups is the % of emails being replied from the sender organization.
m. The method of claim 2 wherein an attribute for determining Bio-Signature Groups is whether an email sender creates emails that are cyclical. For example, a promotion or an organization may send newsletter to their members periodically at a fixed interval.
n. The method of claim 2 wherein an attribute for determining Bio-Signature Groups is whether the attachments have been read.
o. The method of claim 2 wherein an attribute for determining Bio-Signature Groups is whether the sender belongs to a group of highly ranked email organization.
p. The method of claim 2 wherein an attribute for determining Bio-Signature Groups is whether the sender belongs to the Social Network (range of influence) of the recipient.
q. The method of claim 2 wherein an attribute for determining Bio-Signature Groups is whether the sender's emails arrival has a constant interval.

3. The method of scoring is presented and assigned based on weighing the quantification of factors identified in claim 2.
a. The algorithm of claim 3 wherein the attributes of an incoming email or in the inbox are recorded and based on the pattern or user specified, a score is computed.
b. The algorithm of claim 3 wherein the attributes' ranking is kept in a dynamic table where the scoring method can be read from a file or adapted from the user input.
c. The algorithm of claim 3 wherein the attributes' ranking is kept in a dynamic table where the scoring method can be based on the recipient (user's) circle of influence.

4. A display component (a view panel) to show the important emails (automatically assigned or manually assigned).
a. The display component of claim 3, wherein the collected emails are displayed in a dock-able window inside the hosting email client, such as Microsoft Outlook. The displays design is presented in FIG. 3 and FIG. 4. One is a chronologically ordered linear list while the other is the tree view of Priority Queues.
b. The display components of claim 3, wherein the organization of the collected email is in chronological order or in the order so chosen by the user.
c. The display components of claim 3, wherein the amount of emails displayed in this panel is limited to the current day minus the number of days to display specified. For example, if the number of days to display is 7, then this VIP panel will only display emails of high importance that have been received within the past 7 days. This value can be altered.

5. An algorithm to employ the unequivocal relationship between “Bio-Signature” and the level of importance of an email from the viewpoint of the user.
a. The algorithmic component of claim 5, wherein the algorithm is specifying the attributes identified ad hoc or based on presumptuous derivation of an observation to assign weights and the resulting accumulative score of each “sender” of interest.
b. The algorithmic component of claim 5, wherein the algorithm specified is dynamically adjusted based on real-time events that triggered by two event types: incoming emails and the user interactions.
c. The algorithmic component of claim 5, wherein the attributes and scoring weights are determined by the user if so preferred. The aggregate of the attributes weights determines the scores of a sender's profile priority.
d. The algorithmic component of claim 5, wherein there are “OR” and “AND” relationships between attributes. For example, if a sender is in the participant network in which one or more of participants in such network is in a high level of importance setting, then emails from this sender is automatically assigned a higher level of importance in the scoring scheme.
e. The algorithmic component of claim 5, wherein there are attributes which do not have causal relationship to another attribute. For example, the timestamp the email is received and when it is read is a totally independent scoring attribute. However, it may be modified by assessing the start time of the Email Client in which the viewing is performed.
